(19) United States
(12) Patent Application Publication
(10) Pub. No.: US 2023/0373768 A1
(43) Pub. Date: Nov. 23, 2023

(54) INFLATABLE POSITIONING DEVICE

(71) Applicant: Calculated Industries, Inc., Carson City, NV (US)

(72) Inventors: Mark E. Paulsen, Carson City, NV (US); Michael A. Diamond, Carson City, NV (US)

(21) Appl. No.: 18/320,864

(22) Filed: May 19, 2023

Related U.S. Application Data
(60) Provisional application No. 63/343,584, filed on May 19, 2022.

(51) Int. Cl. B66F 3/35

(52) U.S. Cl. CPC B66F 3/35; B66F 2700/09

(57) ABSTRACT

A device may include a captive rigid support plate. A device may include an inflatable bladder including one or more inflatable bladder portions made of airtight material. A device may include a rigid external surface wherein, the rigid external surface includes an area proximal to the captive rigid support plate. A device may include a hose-receiving interface coupled to at least one of the inflatable bladder portions. A device may include an inflation hose coupled to the hose-receiving interface. A device may include an inflating component coupled to the inflation hose. A device may include an integrated bleed valve coupled to one or more of at least one of the inflatable bladder portions, the inflation hose, or the inflating component.

### CROSS-REFERENCE TO RELATED APPLICATIONS

This application claims priority through the applicant's prior U.S. Provisional Patent Application No. 63/343,584 entitled “INFLATABLE POSITIONING BLADDER” filed on May 19, 2022, which application is hereby incorporated by reference in its entirety.

### COPYRIGHT

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright rights.

### TECHNICAL FIELD

The present disclosure is directed to an inflatable positioning device, and more specifically to an inflatable positioning device with a rigid support plate operable to one or more of lift, level, position, pry, or support objects.

### BACKGROUND ART

Inflatable positioning devices have been widely used in various industries for one or more of lifting, aligning, leveling, positioning, prying, or supporting, such as, for example, for emergency vehicle accident liftings and extractions, locked-door openings, medical patient re-positionings, and the like, as well as for construction installation tasks, thereby providing operators with the ability to work alone to perform certain tasks that would typically require one or more additional operators or assistants. In the construction and installation fields, for example, certain common inflatable positioning devices were typically 6″×6″ square or 4″×10″ rectangular. A hand-pump or foot-pump inflation bulb or other inflating components was often used to inflate the bladder to the desired height or width, depending on positioning, and an integrated bleed valve was typically used to lower or thin, either for small downward or horizontal adjustments, or to fully deflate.

The inflatable positioning device bladders were typically made of a flexible airtight membrane sheet material and positioned in a somewhat flat, fully, or partially deflated state between a supported surface and an object to be moved or positioned. By using an attached flexible airtight hose connected to an inflation bulb or pump, or other commonly-available pressurized air source, the bladder was inflated, lifting or moving the object vertically, horizontally, or laterally away from the supported surface, depending on positioning. As compared to conventional pry bars, levers, and other mechanical lifting methods, this approach had the advantage of providing a soft, pliable surface that was typically less damaging to surrounding support surfaces, such as floors and walls, and also to the object itself. In addition, the inflatable bladder was generally more secure as the pliable inflated bladders were more conforming to the shape of the lifted surface than other methods.

While the aforementioned advantages resulted in increased use of inflatable positioning devices for certain lifting and positioning tasks, these implementations generally suffered from a number of shortcomings and disadvantages. Historically, inflatable positioning device bladders typically over-conformed (i.e., folded around), narrow contacting surfaces of load objects, where an inflatable bladder lacking appropriate rigidity resulted in the unloaded portion of the inflatable bladder over inflating as compared to the loaded portion.

(e.g., see FIG. 1). This over-conformance generally resulted in one or more of a reduction in the lift distance, positioning distance, or degree of support, of the load object. This was typically due, at least in part, to bladder inflation occurring predominantly in the unloaded portions of the bladder (e.g., on either side of the narrow contacting surface of the load object), leaving the center portion under the object with inadequate or reduced lift, movement, or support. The overall result was often one or more of reduced lifting or positioning height, reduced stability, and reduced effectiveness. This often then further resulted in the use of unsafe or damaging lifting or positioning apparatus, the costly use of one or more additional assistants, or both.

Some historical implementations of inflatable positioning devices included placing or introducing an uncoupled rigid plate between the inflatable positioning device bladder and load to improve the height adjustment or width adjustment. This often suffered from various shortcomings, including, but not limited to, an increased likelihood of the loss of the rigid plate, instability associated with placing an uncoupled rigid plate between the inflatable positioning device bladder and the load object, the slippery nature of most rigid plate surfaces, and the increased likelihood of movement of the load object off the rigid plate, sometimes resulting in a puncture to the inflatable bladder, the breaking of the load object at or near the point of contact with the rigid plate, or both.

Still other implementations included placing and inflating the inflatable bladder inside an independent pouch cavity that included one or more rigid plates connected to an elastic belt along the circumference. This configuration suffered from a variety of problems and resulting disadvantages. First, due to the elastic nature of the belt, the rigid plate was prone to failing to retain its position in relation to the inflatable bladder, as one side of the elastic portion of the pouch was free to stretch to a greater degree than the other side, particularly when the center of gravity of the load object was not exactly at or very near the center point of the inflatable bladder. Further to this, the positioning of the rigid plate was susceptible itself to being not centered with respect to the inflatable bladder, further exacerbating problems associated with creating unstable lifting surface.

In addition, part of the value of the inflatable positioning device was its simplicity, low cost, ease of use, and small form factor. The addition of an independent pouch introduced additional costs, additional bulk, and unnecessary complexity to what was initially a simple lifting device. Further to this, the introduction of additional components increased the number of possible points of failure, as well increased the likelihood of misplacing an independent component. Further still, these pouches and external plates typically introduced additional manufacturing burdens related to additional materials such as elastic, additional surface materials and adhesives for addressing slippage issues associated with the exposed natural surface of the rigid plate, and the tooling required to manufacture the independent pouches. Yet another problem with this approach was the increase in size, thickness, or both of the combined apparatus due to the independent pouch, which sometimes made it difficult to place the apparatus between the support object surface and the load object.

### SUMMARY OF THE INVENTION

The present disclosure relates to devices for providing an efficient and stable platform for one or more of lifting, positioning, and supporting objects, such as relatively narrow object loads, including but not limited to, for example, doors, windows, plate glass, panels, cabinets, appliances, machinery, equipment, and the like, as commonly lifted, positioned, and supported in, for example, certain home improvement and building trades. The present disclosure further provides for one or more of improved operation, improved efficiency, increased lifting and positioning distance, increased safety, improved stability, improved load object support, improved reliability, reduced cost, reduced complexity, increased puncture resistance, reduced load object damage, reduced load-object breakage, reduced load-object slippage, reduced manufacturing burden, improved ease of use, and reduced form factor, addressing all of the aforementioned problems and disadvantages.

In some embodiments, the inflatable positioning device operable to lift, position, align, or support a load object includes (a) one or more inflatable bladder portions where the inflatable bladder is constructed of one or more of one or more of non-stretchable or limited-stretchable, flexible, airtight membrane sheet material, (b) a hose-receiving interface coupled to at least one of the inflatable bladder portions, (c) an inflation hose coupled to the hose-receiving interface, (d) an inflating component, such as an inflation bulb coupled to the inflation hose, (e) an integrated bleed valve coupled to the inflatable bladder, the inflation hose, or the inflation bulb, and (f) a captive rigid support plate, said plate being smaller in length, smaller in width, or both than the length, width, or both of the inflatable bladder.

In some embodiments, the inflatable positioning device operable to lift, position, align, or support a load object includes (a) an inflatable bladders including multiple inflatable bladder portions where the inflatable bladder portions are constructed of one or more of non-stretchable or limited-stretchable, flexible, airtight membrane sheet material, (b) a hose-receiving interface coupled to at least one of the inflatable bladder portions, (c) an inflation hose coupled to the hose-receiving interface, (d) an inflating component, such as an inflation bulb coupled to the inflation hose, € an integrated bleed valve coupled to the inflatable bladder, the inflation hose, or the inflation bulb, and (f) a captive rigid support plate, said plate being smaller in length, smaller in width, or both than the length, width, or both of the inflatable bladder.

In another embodiment, the inflatable positioning device operable to lift, position, align, or support a load object includes (a) one or more inflatable bladder portions where the inflatable bladder is constructed of one or more of non-stretchable or limited-stretchable, flexible, airtight membrane sheet material, (b) a hose-receiving interface coupled to at least one of the inflatable bladder portions, (c) an inflation hose coupled to the hose-receiving interface, (d) an inflating component, such as an inflation bulb coupled to the inflation hose, (e) an integrated bleed valve coupled to the inflatable bladder, the inflation hose, or the inflation bulb, and (f) multiple captive rigid support plates, said plates being smaller in length, smaller in width, or both than the length, width, or both of the inflatable bladder.

In another embodiment, the inflatable positioning device operable to lift, position, align, or support a load object includes (a) one or more inflatable bladder portions where the inflatable bladder is constructed of one or more of non-stretchable or limited-stretchable, flexible, airtight membrane sheet material, (b) a hose-receiving interface coupled to at least one of the inflatable bladder portions, (c) an inflation hose coupled to the hose-receiving interface, (d) an inflating component, such as an inflation bulb coupled to the inflation hose, (e) an integrated bleed valve coupled to the inflatable bladder, the inflation hose, or the inflation bulb, and (f) multiple captive rigid support plate segments, said plate segments, in combination, being smaller in length, smaller in width, or both than the length, width, or both of the inflatable bladder.

In another embodiment, the inflatable positioning device operable to lift, position, align, or support a load object includes (a) an inflatable bladders including multiple inflatable bladder portions where the inflatable bladder portions are constructed of one or more of non-stretchable or limited-stretchable, flexible, airtight membrane sheet material, (b) a hose-receiving interface coupled to at least one of the inflatable bladder portions, (c) an inflation hose coupled to the hose-receiving interface, (d) an inflating component, such as an inflation bulb coupled to the inflation hose, (e) an integrated bleed valve coupled to the inflatable bladder, the inflation hose, or the inflation bulb, and (f) multiple captive rigid support plate segments, said plate segments, in combination, being smaller in length, smaller in width, or both than the length, width, or both of the inflatable bladder.

In another embodiment, the inflatable positioning device operable to lift, position, align, or support a load object includes (a) one or more inflatable bladder portions where the inflatable bladder is constructed of one or more of non-stretchable or limited-stretchable, flexible, airtight membrane sheet material, (b) a hose-receiving interface coupled to at least one of the inflatable bladder portions, (c) an inflation hose coupled to the hose-receiving interface, (d) an inflating component, such as an inflation bulb coupled to the inflation hose, (e) an integrated bleed valve coupled to the inflatable bladder, the inflation hose, or the inflation bulb, (f) an integrated plate-receiving pocket positioned on the external top surface of the inflatable bladder configured to receive one or more captive rigid support plates, and (g) at least one removable support plate configured to be insertable into the integrated plate-receiving pocket, said plate being smaller in length, smaller in width, or both than the length, width, or both of the inflatable bladder.

In another embodiment, the inflatable positioning device operable to lift, position, align, or support a load object includes (a) one or more inflatable bladder portions where the inflatable bladder is constructed of one or more of non-stretchable or limited-stretchable, flexible, airtight membrane sheet material, (b) a hose-receiving interface coupled to at least one of the inflatable bladder portions, (c) an inflation hose coupled to the hose-receiving interface, (d) an inflating component, such as an inflation bulb coupled to the inflation hose, (e) an integrated bleed valve coupled to the inflatable bladder, the inflation hose, or the inflation bulb, (f) an integrated plate-receiving pocket positioned on the external top surface of the inflatable bladder configured to receive one or more rigid support plates, and (g) at least one tethered support plate configured to be insertable into the integrated plate-receiving pocket, said plate being smaller in length, smaller in width, or both than the length, width, or both of the inflatable bladder, and said tether connected at one end to a non-inflatable portion of the inflatable positioning device and connected at the other end to the rigid support plate, the tether being long enough to allow the rigid support plate to fully insert into the integrated plate-receiving pocket.

In another embodiment, the inflatable positioning device operable to lift, position, align, or support a load object includes (a) one or more inflatable bladder portions where the inflatable bladder is constructed of one or more of non-stretchable or limited-stretchable, flexible, airtight membrane sheet material, (b) a hose-receiving interface coupled to at least one of the inflatable bladder portions, (c) an inflation hose coupled to the hose-receiving interface, (d) an inflating component, such as an inflation bulb coupled to the inflation hose, (e) an integrated bleed valve coupled to the inflatable bladder, the inflation hose, or the inflation bulb, (f) multiple integrated plate-receiving pockets positioned on the external top surface and external bottom surface of the inflatable bladder, each configured to receive one or more rigid support plates, and (g) at least two removable support plates, each configured to be insertable into at least one of the integrated plate-receiving pockets, said plates being smaller in length, smaller in width, or both than the length, width, or both of the inflatable bladder.

In another embodiment, the inflatable positioning device operable to lift, position, align, or support a load object includes (a) one or more inflatable bladder portions where the inflatable bladder is constructed of one or more of non-stretchable or limited-stretchable, flexible, airtight membrane sheet material, (b) a hose-receiving interface coupled to at least one of the inflatable bladder portions, (c) an inflation hose coupled to the hose-receiving interface, (d) an inflating component, such as an inflation bulb coupled to the inflation hose, (e) an integrated bleed valve coupled to the inflatable bladder, the inflation hose, or the inflation bulb, (f) multiple integrated plate-receiving pockets positioned on the external top surface and external bottom surface of the inflatable bladder, each configured to receive one or more rigid support plates segments, and (g) at least two removable support plate segments, each configured to be insertable into at least one of the integrated plate-receiving pockets, said combination of plates being smaller in length, smaller in width, or both than the length, width, or both of the inflatable bladder.

In another embodiment, the inflatable positioning device operable to lift, position, align, or support a load object includes (a) one or more inflatable bladder portions where the inflatable bladder is constructed of one or more of non-stretchable or limited-stretchable, flexible, airtight membrane sheet material, (b) a hose-receiving interface coupled to at least one of the inflatable bladder portions, (c) an inflation hose coupled to the hose-receiving interface, (d) an inflating component, such as an inflation bulb coupled to the inflation hose, (e) an integrated bleed valve coupled to the inflatable bladder, the inflation hose, or the inflation bulb, (f) multiple integrated plate-receiving pockets positioned on the external top surface and external bottom surface of the inflatable bladder, each configured to receive one or more rigid support plates segments, and (g) at least two tethered removable support plate segments configured to be insertable into at least one of the integrated plate-receiving pocket, said combination of plates being smaller in length, smaller in width, or both than the length, width, or both of the inflatable bladder, and said tether connected at one end to a non-inflatable portion of the inflatable positioning device and connected at the other end to one or more of the rigid support plate segments, the tether being long enough to allow the rigid support plate segments to fully insert into at least one of the integrated plate-receiving pockets.

In some aspects, the techniques described herein relate to an inflatable positioning including: a captive rigid support plate; an inflatable bladder including: one or more inflatable bladder portions including airtight material; a rigid external surface wherein; the rigid external surface includes an area proximal to the captive rigid support plate; a hose-receiving interface coupled to at least one of the inflatable bladder portions; an inflation hose coupled to the hose-receiving interface; an inflating component coupled to the inflation hose; and an integrated bleed valve coupled to one or more of at least one of the inflatable bladder portions, the inflation hose, or the inflating component.

In some aspects, the techniques described herein relate to an inflatable positioning device wherein, a captive rigid support plate length is less than an inflatable bladder length; and a captive rigid support plate width is less than an inflatable bladder width.

In some aspects, the techniques described herein relate to an inflatable positioning device wherein, the captive rigid support plate is mounted to an inside surface of the airtight material.

In some aspects, the techniques described herein relate to an inflatable positioning device wherein, he captive rigid support plate is secured in a fixed position.

In some aspects, the techniques described herein relate to an inflatable positioning device wherein, the inflatable bladder further includes a conforming external surface distal to the captive rigid support plate.

In some aspects, the techniques described herein relate to an inflatable positioning device wherein, the inflating component includes an inflation bulb, the inflation bulb including: a latex material of at 3.00 mm thickness; and a maximum pressure range value of at least 15 psi.

In some aspects, the techniques described herein relate to an inflatable positioning device wherein, the inflation hose and the hose-receiving interface are configured to position the inflation hose at an angle to a proximal inflation bladder edge of less than 45 degrees.

In some aspects, the techniques described herein relate to an inflatable positioning device wherein, the inflation hose and the hose-receiving interface are configured to position the inflation hose at an angle to a proximal inflation bladder edge of greater than 45 degrees and less than 90 degrees.

In some aspects, the techniques described herein relate to an inflatable positioning device, wherein the inflatable bladder further includes external visual plate location indicia.

In some aspects, the techniques described herein relate to an inflatable positioning device, wherein the captive rigid support plate includes a metal.

In some aspects, the techniques described herein relate to an inflatable positioning device wherein the captive rigid support plate includes a thickness between 0.8 mm and 2.0 mm.

In some aspects, the techniques described herein relate to an inflatable positioning device including: a rigid support plate; an inflatable bladder including: one or more inflatable bladder portions including airtight material; an integrated plate-receiving pocket; a rigid external surface wherein; the rigid external surface includes an area proximal to the integrated plate-receiving pocket; a hose-receiving interface coupled to at least one of the inflatable bladder portions; an inflation hose coupled to the hose-receiving interface; an inflating component coupled to the inflation hose; and an integrated bleed valve coupled to one or more of at least one of the inflatable bladder portions, the inflation hose, or the inflating component.

In some aspects, the techniques described herein relate to an inflatable positioning device wherein, the integrated plate-receiving pocket is coupled to an internal surface of the inflatable bladder.

In some aspects, the techniques described herein relate to an inflatable positioning device wherein, the integrated plate-receiving pocket is coupled to an external surface of the inflatable bladder.

In some aspects, the techniques described herein relate to an inflatable positioning device wherein, the inflatable bladder further includes a conforming external surface distal to the integrated plate-receiving pocket.

In some aspects, the techniques described herein relate to an inflatable positioning device including: a rigid support plate; an inflatable bladder including: one or more inflatable bladder portions including airtight material; an external integrated plate-receiving pocket; a rigid external surface wherein; the rigid external surface includes an area proximal to the external integrated plate-receiving pocket; a tether coupled at a first end to the inflatable bladder, an inflation component, or both, and coupled at a second end to the rigid support plate; a hose-receiving interface coupled to at least one of the inflatable bladder portions; an inflation hose coupled to the hose-receiving interface; an inflating component coupled to the inflation hose; and an integrated bleed valve coupled to one or more of at least one of the inflatable bladder portions, the inflation hose, or the inflating component.

In some aspects, the techniques described herein relate to an inflatable positioning device wherein, the inflatable bladder further includes a conforming external surface distal to the external integrated plate-receiving pocket.

In some aspects, the techniques described herein relate to an inflatable positioning device, further including a captive rigid support plate.

In some aspects, the techniques described herein relate to an inflatable positioning device wherein, the inflatable bladder further includes a conforming external surface distal to the captive rigid support plate.

In some aspects, the techniques described herein relate to an inflatable positioning device wherein, he captive rigid support plate is secured in a fixed position.

This combination of an integrated support plate with the inflatable bladder can provide one or more advantages, including but not limited to reducing or eliminating the inflation bladder's over-conformance to the load object shape, broadening the load object contact surface area, increased efficiency with respect to distribution of pneumatic force, and more effective lifts or positionings, such as increased heights.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a perspective view of the prior art over-conforming to a narrow contacting surface of load object;

FIG. 2 is a top plan view of the inflatable positioning device in an uninflated state;

FIG. 3 is a bottom plan view of the inflatable positioning device of FIG. 2 in an uninflated state;

FIG. 4 is a top plan view of the inflatable positioning device of FIG. 2 and an integrated internal pocket encasing an internal captive rigid support plate;

FIG. 5 is a top plan view of the inflatable positioning device of FIG. 2 in an inflated state including external visual plate location indicia;

FIG. 6 is a bottom plan view of the inflatable positioning device of FIG. 2 in an inflated state;

FIG. 7 is a front side plan view of the inflatable positioning device of FIG. 2 in an inflated state;

FIG. 8 is a back side plan view of the inflatable positioning device of FIG. 2 in an inflated state;

FIG. 9 is a perspective view of the inflatable positioning device of FIG. 2 in an inflated state vertically engaged with the contacting surface of a load object;

FIG. 10 is a perspective view of the inflatable positioning device of FIG. 2 in an inflated state horizontally engaged with the contacting surface of a load object;

FIG. 11 is a perspective view of inflatable positioning devices of FIG. 2 in an inflated state vertically and horizontally engaged with contacting surfaces of a load object;

FIG. 12 is a top plan view of the inflatable positioning device of FIG. 2 vertically engaged with the contacting surface of a load object;

FIG. 13 is a top plan view of the inflatable positioning device of FIG. 2 with an externally integrated plate-receiving pocket and a removable rigid support plate;

FIG. 14 is a top plan view of the inflatable positioning device of FIG. 2 with an internally integrated plate-receiving pocket and a rigid support plate;

FIG. 15 is a top plan view of the inflatable positioning device of FIG. 2 with tethered rigid support plate;

FIG. 16 is a top plan view of the inflatable positioning device of FIG. 2 with a tethered rigid support plate engaged with a portion of the rigid plate containing surfaces of each inflatable positioning device;

FIG. 17 is a top plan view of two inflatable positioning devices of FIG. 2 with the bottom of an elongated tethered rigid support plate engaging the internal rigid support plate surfaces; and

FIG. 18 is a top plan view of two inflatable positioning devices of FIG. 2 with the bottom of an elongated tethered rigid support plate engaging the internal rigid support plate surface of one inflatable positioning device and an integrated external plate-receiving pocket.

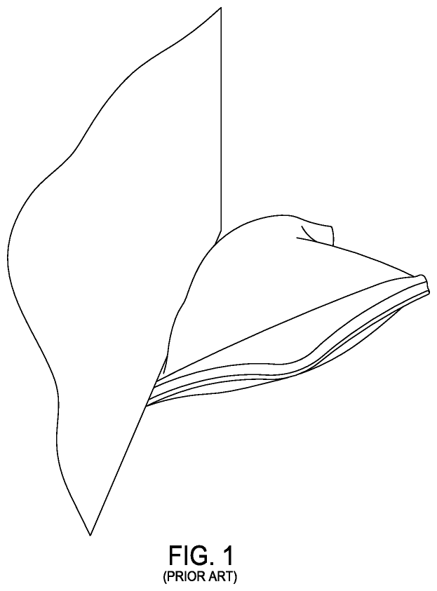

### DETAILED DESCRIPTION

The applicant believes that it has discovered at least one or more of the problems and issues with devices noted above as well as advantages variously provided by differing embodiments of the inflatable positioning device disclosed in this specification.

Briefly and in general terms, the present disclosure provides for one or more of improved operation, improved efficiency, improved stability, improved reliability, reduced cost, reduced complexity, increased puncture resistance, improved ease of use, and reduced form factor.

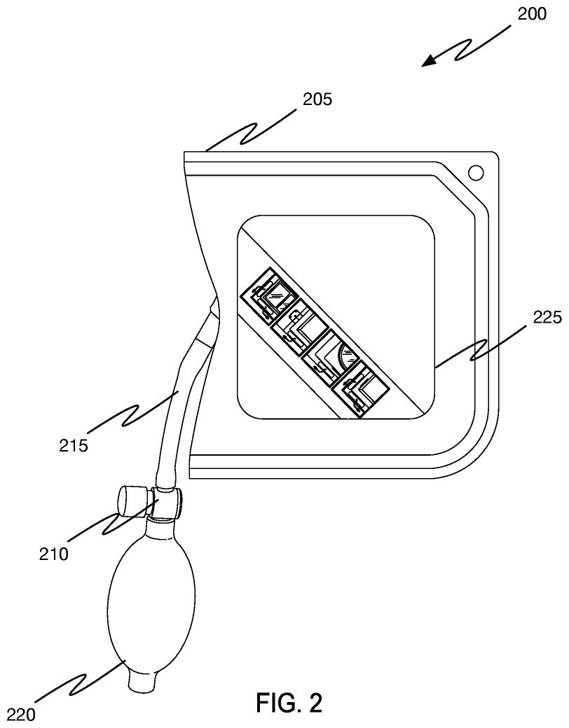

Referring now to FIG. 2, in some embodiments, the inflatable positioning device 200 includes an inflatable bladder 205. The inflatable bladder 205 can be manufactured from one or more materials, either alone or in combination, including, for example, thermoplastic polyurethane (TPU), nylon, PVC, rubber, coated canvas, or other flexible air-tight materials. The inflatable positioning device 200 can further include a bleed valve 210 that can be manufactured using, for example, plastic, such as ABS or PVC, metal, such as brass or steel, or a combination of different materials. The inflation components, including one or more of an inflation hose 215, a bulb 220, a pump, or the like, can be manufactured using various materials, such as PVC, TPU, latex, rubber, or the like. In some embodiments, the inflation bulb is manufactured, at least in part, of a latex material of approximately a 3.00 mm thickness and with a maximum pressure range value of at least 15 psi.

In some implementations, a material with a frictional quality is added to the conforming surface 305 of the inflatable bladder 205 to facilitate frictional retention and reduced slippage of a support object contact surface. In still other embodiments, a different material is added to the bottom surface of the inflatable bladder to facilitate slippage along the support object contact surface.

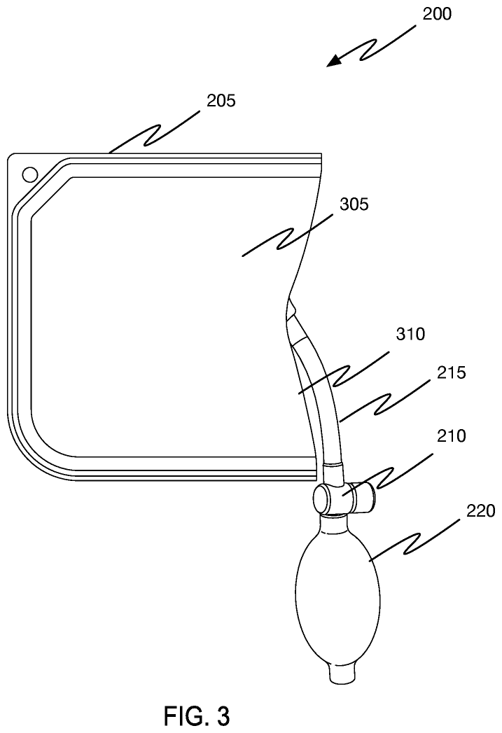

Referring now to FIG. 3, in some instances, the inflation components can be configured such that the inflation hose 215 is positioned at a narrow angle in relation to an edge of the inflatable positioning device 310. In some implementations, this angle is less than 45 degrees. In other implementations, this angle is less or equal to 90 degrees and greater than 45 degrees.

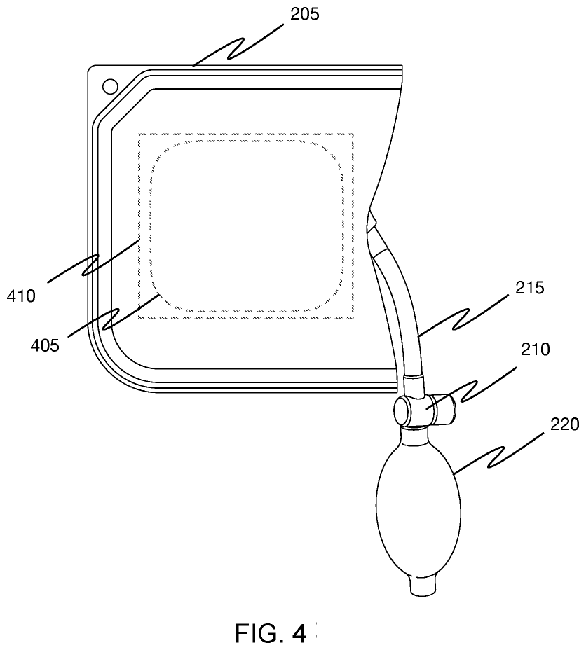

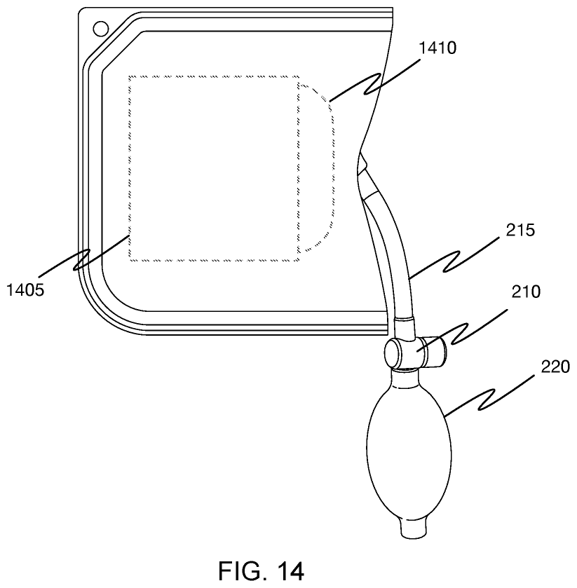

Referring now to FIG. 4, in some embodiments, a captive rigid support plate 405 is mounted to an inside surface of the flexible airtight membrane sheet material. In other embodiments, the captive rigid support plate is sealed within a folding of the flexible airtight membrane sheet material 410. In still other embodiments, the captive rigid support plate is sealed in and held at a fixed position within a sealed plate-receiving pocket of the flexible airtight membrane sheet material (e.g., see FIG. 14, 1405).

In some embodiments, the rigid support plate 405 is planar. In other instances, the rigid support plate is structured, such as, for example, corrugated, curved, v-grooved, or slotted. In some instances, a clamping interface, protruding bracket, or receiving interface, such as a pole, foot, or table leg receiving interface, operable to secure or partially secure a load object is integral to the rigid support plate. In some instances, the rigid support plates are structured such that they can be interlocked with one another, facilitating, for example, the stacking or linking of multiple inflatable positioning devices.

In some instances, the width of the rigid support plate 405 is 3 inches smaller than the width of the inflatable bladder. In some instances, the width of the rigid support plate 405 is 4 inches smaller than the width of the inflatable bladder. In some instances, the rigid support plate 405 is between 2 and 5 inches smaller than the rigid support plate.

In some embodiments, the rigid support plate 405 is a metal material, such as, for example, spring sheet metal or stainless. In some instances, the thickness of the metal material is less than 1.0 mm, such as 0.8 mm. In other embodiments, the rigid support plate 405 is a plastic material, such as, for example, a stiff plastic. In other instances, the thickness of the plastic material is between 1.5 mm and 2.0 mm. In some implementations, the combination of the material and thickness are selected to achieve a degree of rigidity and strength sufficient to fully resist deformation and breakage up to at least an anticipated pound per square inch load, such as up to 15 psi, for example.

In some embodiments, a foldable manufacturing method is employed, creating an integrated plate-receiving pocket from a single flexible airtight membrane sheet. In some implementations, three edges of a first fold are, for example, heat sealed, creating an air-tight portion. Two edges of a second fold are attached to a surface of a portion of the single flexible airtight membrane sheet of the first fold. In some instances, the unattached edge of the second fold is shaped in a way to accommodate the curvature that results when an inflatable bladder portion is inflated.

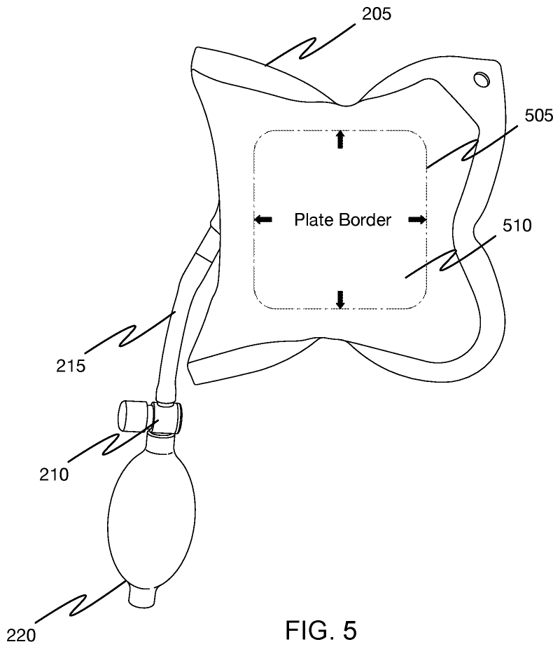

Referring now to FIG. 5. in some instances, the inflatable positioning device 200 includes external visual plate location indicia, such as, for example, a marking, a visually detectable, integral manufacturing artifact, or both. In some instances, the indicia identify the approximate area of the rigid surface where the rigid support plate 505 is located. In some implementations, a design aspect of a label (e.g., see FIG. 2, 225) is suggestive of the approximate area of the rigid support plate.

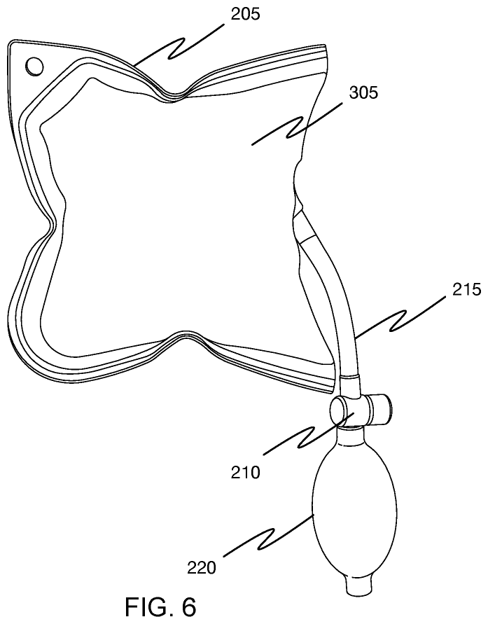

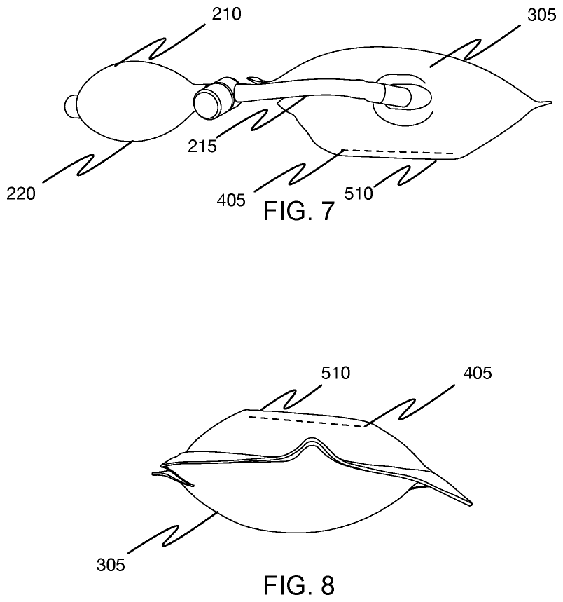

Referring now to FIG. 6, FIG. 7, and FIG. 8, in some embodiments, the inflatable positioning device 200 is reversable, where the rigid surface 510 proximal to the captive rigid support plate 405 is positioned as a lower bottom surface of the inflatable positioning device 200 and the conforming surface 305 distal to the is positioned as an upper surface of the inflatable positioning device 200. In alternative configuration, the reversable inflatable positioning device 200 can be positioned where the rigid surface 510 proximal to the captive rigid support plate 405 is positioned as an upper surface of the inflatable positioning device 200 and the conforming surface 305 distal to the captive rigid support plate 405 is positioned as a lower surface of the inflatable positioning device 200.

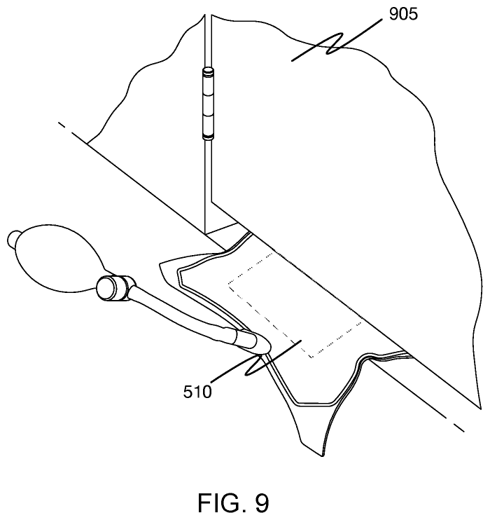

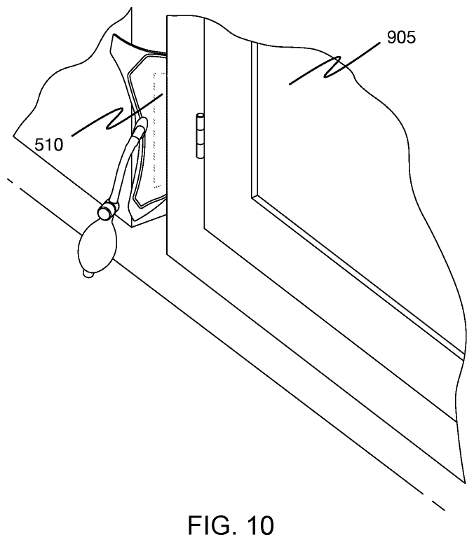

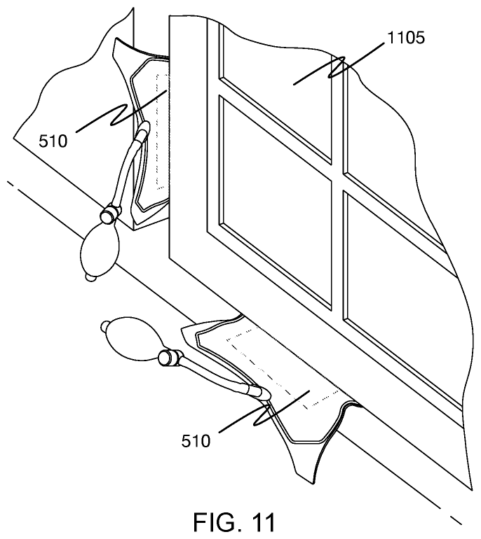

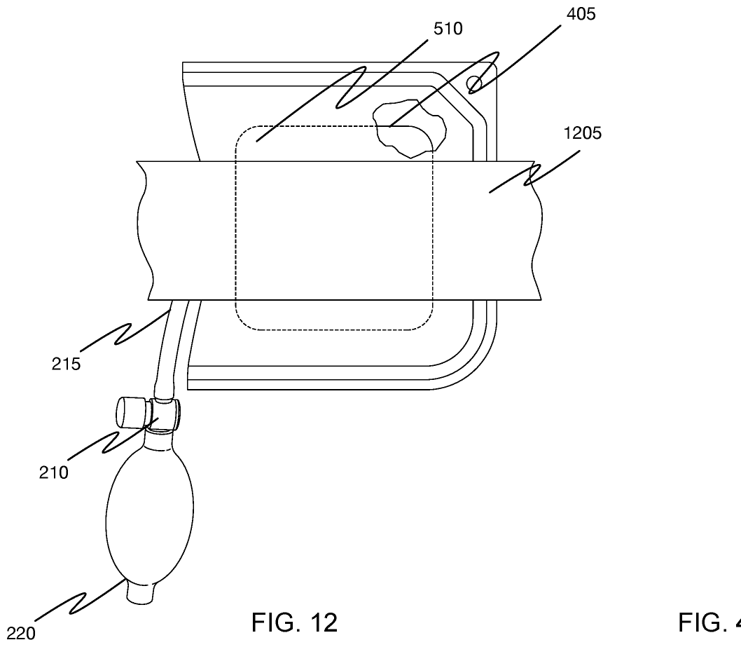

Referring now to FIG. 9, FIG. 10, FIG. 11, and FIG. 12, the inflatable positioning device 200 can be used alone or in combination with one or more additional inflatable positioning devices 200 to support, position, align, lift, level, or the like, a load object 1205, such as, for example, a door 905, a window 1105, where a surface of the load object engages the rigid surface 510 of the inflatable positioning device 200. In some instances, there is a substantially improved lift distance as compared inflatable positioning devices without a rigid support plate.

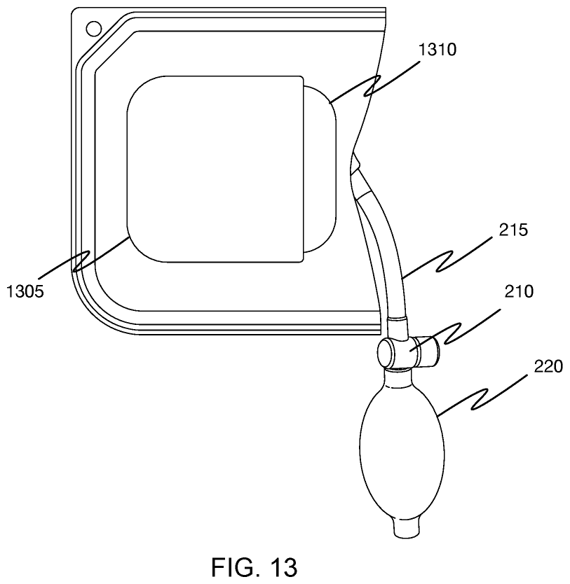

Referring now to FIG. 13, in some embodiments, the inflatable positioning device 100 includes an external plate-receiving pocket 1305 and removable rigid support plate 1310. In some instances, the external plate-receiving pocket 1305 receives a portion of the removable rigid support plate 1310. In other instances, the external plate-receiving pocket 1305 receives the entire removable rigid support plate 1310. In some implementations, the external plate-receiving pocket 1305 is open along a single edge. In some instances, at least one integrated plate-receiving pocket opening is positioned parallel or nearly parallel to an inflatable bladder edge. In some instances, the inflatable bladder edge does not include an inflation hose coupling interface. In some embodiments, the external plate-receiving pocket 1305 is made of the same flexible airtight membrane sheet material as the inflatable bladder 205. In some embodiments, the external plate-receiving pocket 1305 is manufactured from materials the same or similar to those appropriate for the manufacture of the inflatable bladder 205. In some instances, ultrasonic or heat welding/melting procedures are used along a seam. In other instances, chemical or epoxy bonding procedures are used. In some implementations, the external plate-receiving pocket 1305 is a non-integral pocket attached to the inflatable bladder 205 by one or more of Velcro/hook-and-loop, dual-locking fasteners (e.g., mushroom-shaped fasteners), magnetic strips, interlocking snaps, rails/grooves, stitches, tabs/slots, and the like.

Referring now to FIG. 14, in some embodiments, an inflatable positioning includes an internal rigid support plate 1410. In some instances, the internal rigid support plate 1410 is a captive or partially captive rigid plate at least partially held in place by an integrated plate-receiving pocket attached to the interior surface of the inflatable bladder. In another instance, the rigid support plate is a captivated rigid plate at least partially held in place by a pocket attached to the interior surface of the inflatable bladder.

In some embodiments, the plate-receiving pocket 1405 can be an adhesively coupled, magnetically coupled, stitched, welded, or the like, two-sided or one-sided pocket. In some instances, the plate-receiving pocket 1405 can be formed from a contiguous portion of the inflatable bladder through, for example, a tri-folding manufacturing process. In some embodiments, the pocket is a single sheet of material secured to an internal or external surface of the inflatable bladder along a portion of the edges of the single sheet of material, such as with glue, by welding, or by other attachment methods understood by those of ordinary skill in the art. In some embodiments, the 1405 plate-receiving pocket is open on a single end. In another embodiment, the 1405 plate-receiving pocket is open on two opposing ends. In some embodiments, the 1405 plate-receiving pocket is made of the same material as the inflatable bladder. In another embodiment, the 1405 plate-receiving pocket is made of a different material from the inflatable bladder material.

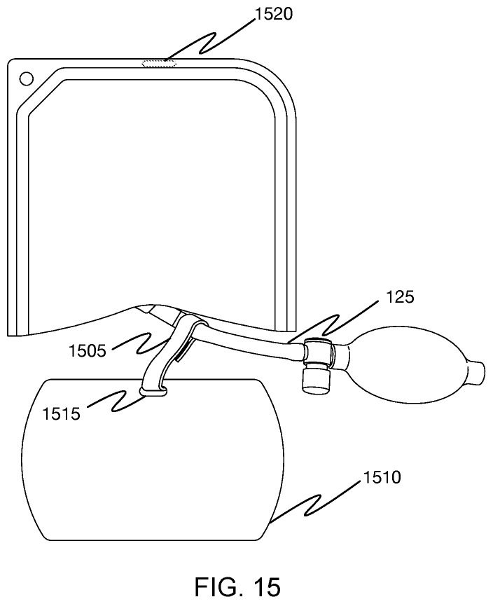

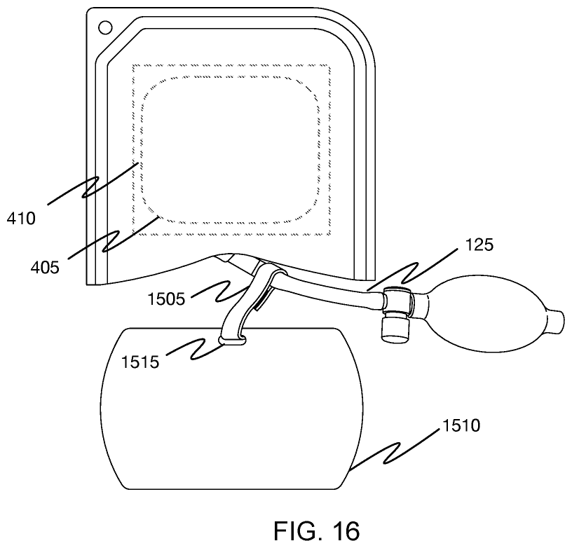

Referring now to FIG. 15 and FIG. 16, in some embodiments, the inflatable positioning device includes a tether 1505 and tetherable rigid support plate 1510, where the tetherable rigid support plate 1510 is tethered to an inflatable positioning device 100. In some instances, the proximal end of the tether 1505 is coupled to the inflatable hose 125, and the distal end of the tether 1505 is coupled to the tetherable rigid support plate 1510, such as the tether 1505 being threaded through a hole proximal to rigid support plate edge 1515. In other instances, the proximal end of the tether 1505 is coupled to a hole 1520 in the non-inflatable area of the flexible airtight membrane sheet material. The tether 1505 can be made of various materials, either alone or in combination, including, for example, nylon, rubber, PVC twine/cord, leather, chain, plastic ties (e.g., zip ties) or woven (polypropylene) straps. By contrast, where a tethered rigid support plate is positioned between a portion of the external flexible airtight membrane sheet material and a load object contact surface, the pneumatic pressure is more evenly distributed throughout the inflatable bladder, resulting in an increased stability, increased lift efficiency, or both.

In some embodiments, the inflatable bladder is made up of multiple inflatable bladder portions. In some implementations, the inflatable bladder includes a container portion encapsulating multiple inflatable bladder portions. In some instances, inflatable bladder portions are positioned approximately parallel to one another. In some embodiments, at least two of the bladder portions are independently inflatable. In still other instances, inflatable bladder portions are chambered such that they are inflated from a single inflation point. In some implementations, the inflatable bladder portions share one or more separators. In other implementations, the inflatable bladder portions are structurally independent from one another in that they do not share a separator with other inflatable bladder portions. In some instances, each inflatable bladder portion is independently removable from a container portion, replaceable within a container portion, or both. In some instances, each independent inflatable bladder portion is connected to at least one other inflatable bladder portion. In some instances, at least one inflatable bladder portion is connected to the container portion. In other instances, there is no container portion independent of the multiple inflatable bladder portions.

In some embodiments, a rigid support plate spans at least a portion of each inflatable bladder portion. In some instances, a rigid support plate spans less than all the inflatable bladder portions. In some implementations, a rigid support plate segment spans at least a portion of at least two inflatable bladder portions. In other implementations, a rigid support plate segment spans at least a portion of only one inflatable bladder portion. In some embodiments, at least one support plate segment portion is coupled to a single bladder portion. In some embodiments, an integrated plate-receiving pocket is positioned on the external top surface of at least one inflatable bladder portion and is configured to receive one rigid support plate segment. In other embodiments, an integrated plate-receiving pocket is positioned on the external top surface of multiple inflatable bladder portions and is configured to receive one rigid support plate or multiple rigid support plate segments.

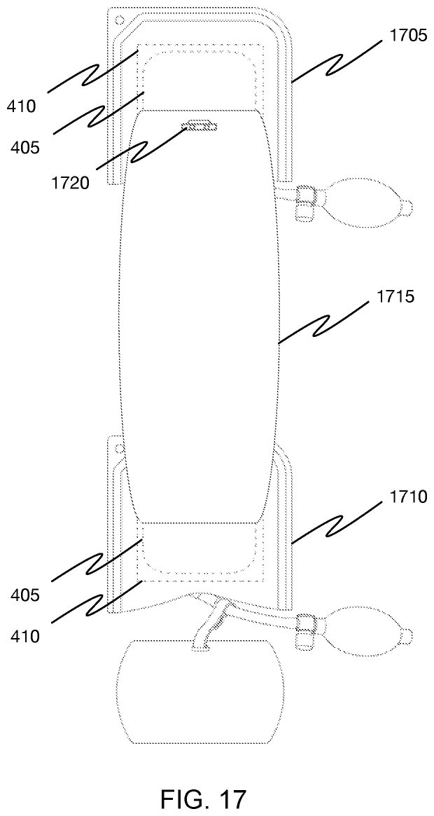

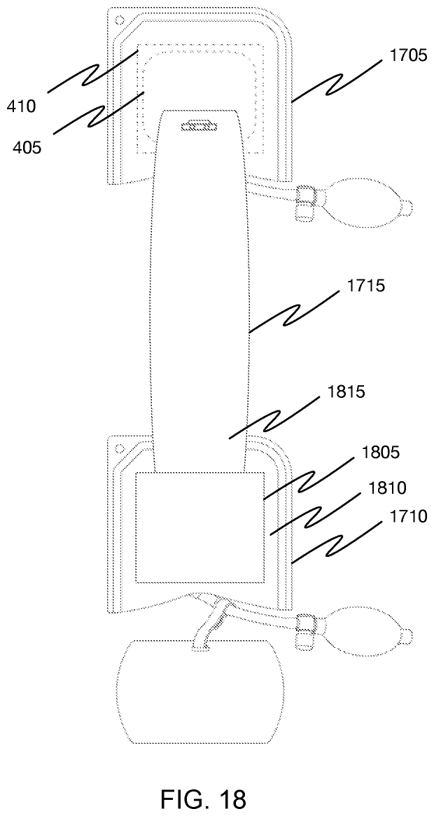

Referring now to FIG. 17 and FIG. 18, in some embodiments, In some embodiments, the inflatable positioning device configuration is made up of multiple inflatable positioning devices 1705, 1710 in combination with an elongated rigid support plate 1715. In some instances, the elongated rigid support plate is coupled to one of the inflatable positioning devices using a tether 1720. In some implementations the inflatable positions devices are positioned along a line approximately parallel to one edge of each inflatable bladder. In some embodiments, the multiple bladders are independently inflatable. In still other instances, the inflatable bladders are inflated simultaneously from a single inflation point.

In some embodiments, the elongated rigid support plate 1715 spans at least a portion of each inflatable bladder of the inflatable positioning device 1705, 1710. In some instances, the elongated rigid support plate spans less than one or more of the inflatable bladders of the inflatable positioning devices 1705, 1710. In some implementations, an elongated rigid support plate spans at least a portion of at least two inflatable bladders of the inflatable positioning device 1705, 1710. In other implementations, a rigid support plate segment spans at least a portion of only one inflatable positioning device 1705, 1710. In some embodiments, an external plate-receiving pocket 1805 is positioned on the external top surface 1810 of at least one inflatable bladders of the inflatable positioning device 1710 and is configured to receive an elongated rigid support plate end 1815. In other embodiments, an external plate-receiving pocket 1805 is positioned on the external top surface of multiple inflatable bladder portions where each pocket is configured to receive an end of the elongated rigid support plate 1715. In some instances, the multiple inflatable positioning device configuration includes at least one inflatable positioning device that includes a captive internal rigid support plate 405. In other instances, the multiple inflatable positioning device configuration includes inflatable positioning devices that do not includes captive internal rigid support plates.
Clause 1. An inflatable positioning device comprising: a captive rigid support plate; an inflatable bladder comprising: one or more inflatable bladder portions comprising airtight material; a rigid external surface wherein; the rigid external surface comprises an area proximal to the captive rigid support plate; a hose-receiving interface coupled to at least one of the inflatable bladder portions; an inflation hose coupled to the hose-receiving interface; an inflating component coupled to the inflation hose; and an integrated bleed valve coupled to one or more of at least one of the inflatable bladder portions, the inflation hose, or the inflating component.
Clause 2. The inflatable positioning device of claim 1 wherein, a captive rigid support plate length is less than an inflatable bladder length; and a captive rigid support plate width is less than an inflatable bladder width.
Clause 3. The inflatable positioning device of claim 1 wherein, the captive rigid support plate is mounted to an inside surface of the airtight material.
Clause 4. The inflatable positioning device of claim 1 wherein, he captive rigid support plate is secured in a fixed position.
Clause 5. The inflatable positioning device of claim 1 wherein, the inflatable bladder further comprises a conforming external surface distal to the captive rigid support plate.
Clause 6. The inflatable positioning device of claim 1 wherein, the inflating component comprises an inflation bulb, the inflation bulb comprising: a latex material of at 3.00 mm thickness; and a maximum pressure range value of at least 15 psi.
Clause 7. The inflatable positioning device of claim 1 wherein, the inflation hose and the hose-receiving interface are configured to position the inflation hose at an angle to a proximal inflation bladder edge of less than 45 degrees.
Clause 8. The inflatable positioning device of claim 1 wherein, the inflation hose and the hose-receiving interface are configured to position the inflation hose at an angle to a proximal inflation bladder edge of greater than 45 degrees and less than 90 degrees.
Clause 9. The inflatable positioning device of claim 1, wherein the inflatable bladder further comprises external visual plate location indicia.
Clause 10. The inflatable positioning device of claim 1, wherein the captive rigid support plate comprises a metal.
Clause 11. The inflatable positioning device of claim 10 wherein the captive rigid support plate comprises a thickness between 0.8 mm and 2.0 mm.
Clause 12. An inflatable positioning device comprising: a rigid support plate; an inflatable bladder comprising: one or more inflatable bladder portions comprising airtight material; an integrated plate-receiving pocket; a rigid external surface wherein; the rigid external surface comprises an area proximal to the integrated plate-receiving pocket; a hose-receiving interface coupled to at least one of the inflatable bladder portions; an inflation hose coupled to the hose-receiving interface; an inflating component coupled to the inflation hose; and an integrated bleed valve coupled to one or more of at least one of the inflatable bladder portions, the inflation hose, or the inflating component.
Clause 13. The inflatable positioning device of claim 12 wherein, the integrated plate-receiving pocket is coupled to an internal surface of the inflatable bladder.
Clause 14. The inflatable positioning device of claim 12 wherein, the integrated plate-receiving pocket is coupled to an external surface of the inflatable bladder.
Clause 15. The inflatable positioning device of claim 12 wherein, the inflatable bladder further comprises a conforming external surface distal to the integrated plate-receiving pocket.
Clause 16. An inflatable positioning device comprising: a rigid support plate; an inflatable bladder comprising: one or more inflatable bladder portions comprising airtight material; an external integrated plate-receiving pocket; a rigid external surface wherein; the rigid external surface comprises an area proximal to the external integrated plate-receiving pocket; a tether coupled at a first end to the inflatable bladder, an inflation component, or both, and coupled at a second end to the rigid support plate; a hose-receiving interface coupled to at least one of the inflatable bladder portions; an inflation hose coupled to the hose-receiving interface; an inflating component coupled to the inflation hose; and an integrated bleed valve coupled to one or more of at least one of the inflatable bladder portions, the inflation hose, or the inflating component.
Clause 17. The inflatable positioning device of claim 16 wherein, the inflatable bladder further comprises a conforming external surface distal to the external integrated plate-receiving pocket.
Clause 18. The inflatable positioning device of claim 16, further comprising a captive rigid support plate.
Clause 19. The inflatable positioning device of claim 18 wherein, the inflatable bladder further comprises a conforming external surface distal to the captive rigid support plate.
Clause 20. The inflatable positioning device of claim 18 wherein, he captive rigid support plate is secured in a fixed position.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

In places where the description above refers to particular implementations of an inflatable positioning device, it should be readily apparent that a number of modifications may be made without departing from the spirit thereof and that these implementations may be applied to inflatable positioning bladders. It will be understood that implementations are not limited to the specific components disclosed herein, as virtually any components consistent with the intended operation of an inflatable positioning device may be utilized. Accordingly, for example, although particular inflatable positioning device components may be disclosed, such components may comprise any shape, size, style, type, model, version, class, grade, measurement, material, weight, quantity, and/or the like consistent with the intended operation of a method and/or system implementation for an inflatable positioning bladder.

Unless otherwise noted, the terms “a” or “an,” as used in the specification are to be construed as meaning “at least one of” In addition, for ease of use, the words “including” and “having,” as used in the specification, are interchangeable with and have the same meaning as the word “comprising.” In addition, the term “based on” as used in the specification is to be construed as meaning “based at least upon.”

What is claimed is:

1. An inflatable positioning device comprising:
a captive rigid support plate;
an inflatable bladder comprising:
one or more inflatable bladder portions comprising airtight material;
a rigid external surface wherein;
the rigid external surface comprises an area proximal to the captive rigid support plate;
a hose-receiving interface coupled to at least one of the inflatable bladder portions;
an inflation hose coupled to the hose-receiving interface;
an inflating component coupled to the inflation hose; and
an integrated bleed valve coupled to one or more of at least one of the inflatable bladder portions, the inflation hose, or the inflating component.

2. The inflatable positioning device of claim 1 wherein,
a captive rigid support plate length is less than an inflatable bladder length; and
a captive rigid support plate width is less than an inflatable bladder width.

3. The inflatable positioning device of claim 1 wherein, the captive rigid support plate is mounted to an inside surface of the airtight material.

4. The inflatable positioning device of claim 1 wherein, he captive rigid support plate is secured in a fixed position.

5. The inflatable positioning device of claim 1 wherein, the inflatable bladder further comprises a conforming external surface distal to the captive rigid support plate.

6. The inflatable positioning device of claim 1 wherein, the inflating component comprises an inflation bulb, the inflation bulb comprising:
a latex material of at 3.00 mm thickness; and
a maximum pressure range value of at least 15 psi.

7. The inflatable positioning device of claim 1 wherein, the inflation hose and the hose-receiving interface are configured to position the inflation hose at an angle to a proximal inflation bladder edge of less than 45 degrees.

8. The inflatable positioning device of claim 1 wherein, the inflation hose and the hose-receiving interface are configured to position the inflation hose at an angle to a proximal inflation bladder edge of greater than 45 degrees and less than 90 degrees.

9. The inflatable positioning device of claim 1, wherein the inflatable bladder further comprises external visual plate location indicia.

10. The inflatable positioning device of claim 1, wherein the captive rigid support plate comprises a metal.

11. The inflatable positioning device of claim 10 wherein the captive rigid support plate comprises a thickness between 0.8 mm and 2.0 mm.

12. An inflatable positioning device comprising:
a rigid support plate;
an inflatable bladder comprising:
one or more inflatable bladder portions comprising airtight material;
an integrated plate-receiving pocket;
a rigid external surface wherein;
the rigid external surface comprises an area proximal to the integrated plate-receiving pocket;
a hose-receiving interface coupled to at least one of the inflatable bladder portions;
an inflation hose coupled to the hose-receiving interface;
an inflating component coupled to the inflation hose; and
an integrated bleed valve coupled to one or more of at least one of the inflatable bladder portions, the inflation hose, or the inflating component.

13. The inflatable positioning device of claim 12 wherein, the integrated plate-receiving pocket is coupled to an internal surface of the inflatable bladder.

14. The inflatable positioning device of claim 12 wherein, the integrated plate-receiving pocket is coupled to an external surface of the inflatable bladder.

15. The inflatable positioning device of claim 12 wherein, the inflatable bladder further comprises a conforming external surface distal to the integrated plate-receiving pocket.

16. An inflatable positioning device comprising:
a rigid support plate;
an inflatable bladder comprising:
one or more inflatable bladder portions comprising airtight material;
an external integrated plate-receiving pocket;
a rigid external surface wherein;
the rigid external surface comprises an area proximal to the external integrated plate-receiving pocket;
a tether coupled at a first end to the inflatable bladder, an inflation component, or both, and coupled at a second end to the rigid support plate;
a hose-receiving interface coupled to at least one of the inflatable bladder portions;
an inflation hose coupled to the hose-receiving interface;
an inflating component coupled to the inflation hose; and
an integrated bleed valve coupled to one or more of at least one of the inflatable bladder portions, the inflation hose, or the inflating component.

17. The inflatable positioning device of claim 16 wherein, the inflatable bladder further comprises a conforming external surface distal to the external integrated plate-receiving pocket.

18. The inflatable positioning device of claim 16, further comprising a captive rigid support plate.

19. The inflatable positioning device of claim 18 wherein, the inflatable bladder further comprises a conforming external surface distal to the captive rigid support plate.

20. The inflatable positioning device of claim 18 wherein, he captive rigid support plate is secured in a fixed position.
